(19) United States
(12) Patent Application Publication
(10) Pub. No.: US 2025/0192279 A1
(43) Pub. Date: Jun. 12, 2025

(54) TEMPERATURE CONTROL DEVICE, IN PARTICULAR COOLING DEVICE FOR A MOTOR VEHICLE

(71) Applicant: VALEO SYSTEMES THERMIQUES, La Verriere (FR)

(72) Inventors: Cedric DE VAULX, La Verriere (FR); Erwan ETIENNE, La Verriere (FR); Kamel AZZOUZ, La Verriere (FR); Jean Christophe LHERMITTE, La Verriere (FR)

(73) Assignee: VALEO SYSTEMES THERMIQUES, La Verriere (FR)

(21) Appl. No.: 18/845,237

(22) PCT Filed: Feb. 15, 2023
(86) PCT No.: PCT/EP2023/053801

§ 371 Date: Sep. 9, 2024

(30) Foreign Application Priority Data
Mar. 8, 2022 (FR) 2201992

(51) Int. Cl. H01M 10/6568; H01M 10/613; H01M 10/625

(52) U.S. Cl. CPC H01M 10/6568; H01M 10/613; H01M 10/625

(57) ABSTRACT

The invention relates to a temperature control device, notably a cooling device, for an electrical component liable to give off heat during operation, notably for an electrical energy storage module, the device including at least one circulation channel for a heat-transfer fluid and having, in cross section, a substantially trapezoid contour with two side walls and a bottom wall, this bottom wall corresponding to a small base of the trapezoid, this channel being provided, on at least one of the side walls thereof, with a lateral disruption element for disrupting the flow of the heat-transfer fluid in this channel, and, on the bottom wall, with a bottom disruption element, these disruption elements being arranged at a distance from one another.

### TECHNICAL FIELD

The present invention relates to a temperature control device, notably a cooling device, notably for an electrical component liable to give off heat when in operation, notably a device for cooling at least one battery or battery cells of a motor vehicle.

### BACKGROUND OF THE INVENTION

Vehicle batteries, in particular for electric vehicles or hybrid vehicles, should as much as possible be kept at the desired temperature, which is why devices known as cooling devices are used for vehicle batteries. These cooling devices comprise cooling plates through which a cooling fluid circulates. Cooling devices that use two plates that are fastened to one another to form channels for the cooling fluid are known. Patent EP 2 828 922 B1 describes such a device.

Patent application WO12126111 describes a battery cell cooling device comprising a pair of complementary plates, the pair of complementary plates together forming a flow passage having an inlet end, an outlet end and dimples or ribs along the length of the flow passage.

### SUMMARY OF THE INVENTION

The invention is intended to propose improved temperature control devices.

The invention thus proposes a temperature control device, notably a cooling device, for an electrical component liable to give off heat during operation, notably for an electrical energy storage module, the device including at least one circulation channel for a heat-transfer fluid and having, in cross section, a substantially trapezoid contour with two side walls and a bottom wall, this bottom wall corresponding to a small base of the trapezoid, this channel being provided, on at least one of the side walls thereof, with a lateral disruption element for disrupting the flow of the heat-transfer fluid in this channel, and, on the bottom wall, with a bottom disruption element, these disruption elements being arranged at a distance from one another.

The corners of the trapezoid can be rounded.

The heat-transfer fluid can be a refrigerant fluid, notably a fluid selected from the refrigerant fluids R134a, R1234yf and R744, or a water/ethylene glycol mixture.

The invention enables these disruption elements to be selected, for example from several different types with different spacing distances, to create suitable turbulence in the flow to achieve a desired heat exchange coefficient to cool the components to the desired temperature.

According to one of the aspects of the invention, the lateral disruption element projects from the side wall.

According to one of the aspects of the invention, the lateral disruption element has a base that extends over the side wall, without encroaching on the bottom wall.

According to one of the aspects of the invention, the bottom disruption element projects from the bottom wall.

According to one of the aspects of the invention, the bottom disruption element has a base that extends over the bottom wall, without encroaching on the side wall.

According to one of the aspects of the invention, each of the disruption elements has a free end, i.e. the height thereof is selected to ensure that they do not come into contact with an opposing wall of the channel.

According to one of the aspects of the invention, the shape of the lateral disruption element is selected to generate turbulence in the fluid flow.

According to one of the aspects of the invention, the lateral disruption element has a base with a rounded contour, notably a circular contour.

According to one of the aspects of the invention, the lateral disruption element is substantially cylindrical or boss-shaped.

According to one of the aspects of the invention, the shape of the bottom disruption element is selected to cause a local acceleration of the flow of the heat-transfer fluid.

According to one of the aspects of the invention, the bottom disruption element is chevron-shaped, comprising two branches that join together at an apex.

According to one of the aspects of the invention, this bottom disruption element is oriented so that the fluid flow first encounters the apex and is then directed to both sides of the two branches of the chevron.

The fluid can thus be accelerated by this bottom disruption element.

According to one of the aspects of the invention, the channel is provided with a plurality of lateral disruption elements and a plurality of bottom disruption elements.

According to one of the aspects of the invention, the lateral disruption elements are present on both side walls, notably forming pairs of lateral disruption elements that face one another on both sides of the bottom wall.

In a variant, the lateral disruption elements of one row are arranged alternately with the disruption elements of the other row.

According to one of the aspects of the invention, each side wall is provided with a row of lateral disruption elements that are notably spaced apart from one another at a constant pitch in each row.

According to one of the aspects of the invention, these lateral disruption elements are all identical in the row.

According to one of the aspects of the invention, the channel has a row of bottom disruption elements that are notably spaced apart from one another at a constant pitch.

According to another aspect of the invention, the channel has a row of bottom disruption elements that are notably spaced apart from one another by a variable pitch.

This variable pitch advantageously enables the heat transfer coefficient (HTC) to be adjusted along the flow.

According to one of the aspects of the invention, these bottom disruption elements are all identical in the row.

According to one of the aspects of the invention, the rows of lateral disruption elements are offset from the row of bottom disruption elements so that, in the direction of the rows, the bottom disruption elements are located between two consecutive pairs of lateral disruption elements, notably equidistant from two consecutive pairs of lateral disruption elements or at different distances from consecutive pairs.

In other words, the bottom disruption elements are not aligned with the neighboring lateral disruption elements.

This ensures a high heat exchange coefficient without unduly worsening the pressure drops, on account of the alternating turbulence-creation zones (resulting from the lateral disruption elements) and fluid-acceleration zones (resulting from the bottom disruption elements).

According to one of the aspects of the invention, the distance D, measured in a longitudinal direction, between one of the bottom disruption elements and the neighboring lateral disruption element, satisfies the following relationship: dp-L/(2 tan (α/2))<D<L/(2 tan (α/2)).

According to one of the aspects of the invention, the distance D, measured in a longitudinal direction, between one of the bottom disruption elements and the neighboring lateral disruption element, satisfies the most generic formula below to also provide the option of a variable pitch and/or a variable chevron shape:

$${dp}_{i , i + 1} - \frac{L}{2 ta ( \frac{{α}_{i}}{2} )} < D < \frac{L}{2 tan ( \frac{{α}_{i}}{2} )}$$

where the index i refers to the channel bottom dimple located upstream of the flow, and the index i+1 refers to the next dimple located downstream of the flow, dp is the pitch between the bottom disruption elements, L is the width of the bottom wall of the channel, and a is the angle at the apex of the chevron shape.

This relationship means that the lateral disruption elements are behind the triangle formed by the chevron-shaped bottom disruption element.

This means that the fluid is accelerated by the chevron-shaped bottom disruption element, then turbulence is generated in the flow by the lateral disruption elements, at a suitable distance from the apex of the chevron.

The invention provides an optimized heat exchange coefficient.

According to one of the aspects of the invention, the disruption elements are formed on a straight section of the channel.

According to one of the aspects of the invention, the channel has a succession of straight sections connected together by bends.

According to one of the aspects of the invention, the temperature control device comprises a plurality of channels, notably arranged parallel to one another, and the channels are provided with disruption elements arranged as described above.

According to one of the aspects of the invention, the temperature control device has an upper plate and a lower plate assembled, notably by brazing, with the upper plate in order to form together the plurality of circulation channels for the heat-transfer fluid.

According to one of the aspects of the invention, the upper plate is substantially flat to be brought into thermal contact with the components to be cooled.

According to one of the aspects of the invention, the disruption elements are formed on the lower plate, notably by drawing, stamping or metal additive manufacturing.

According to one of the aspects of the invention, the trapezoids of the contours of the channels are isosceles trapezoids.

According to one of the aspects of the invention, the modules to be cooled have a rectangular base.

The invention also relates to an assembly having at least two electrical components liable to give off heat during operation, notably at least one electrical energy storage module, and a temperature control device as described above, arranged to cool these components placed respectively on the temperature control device.

The module is for example a motor-vehicle battery pack.

### BRIEF DESCRIPTION OF DRAWINGS

Other characteristics and advantages of the invention will become more apparent from reading the following description, provided by way of non-limiting illustration, and from the appended drawings in which:

FIG. 1 is a partial schematic view of a temperature control device according to an example embodiment of the invention,

FIG. 2 is a partial schematic cross-section view of the lower plate of the device in [FIG. 1], and

FIG. 3 is a partial schematic view of the layout of the disruption elements of a channel of the device in [FIG. 1].

### DETAILED DESCRIPTION OF THE INVENTION

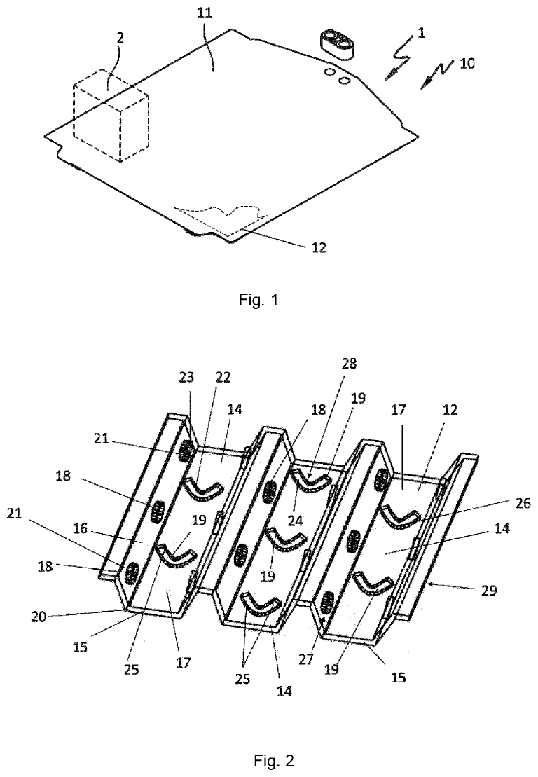

FIG. 1 shows an assembly 1 having a module 2 of battery cells to be cooled, in a motor vehicle.

The battery cells comprise, for example, a plurality of lithium-ion (Li-ion) batteries for use in a hybrid vehicle. In another embodiment, the plurality of battery cells are Li-ion batteries for use in a battery-powered electric vehicle.

The assembly 1 further comprises a temperature control device 10 arranged to cool the cells of the module 2, which are in thermal contact with an upper plate of the cooling device 10, as explained below.

The temperature control device 10 has an upper plate 11, a lower plate 12 joined to the upper plate 11 such that the plates together form a plurality of circulation channels 14 for a heat-transfer fluid, in this case a refrigerant fluid selected from the refrigerant fluids R134a, R1234yf and R744.

The plates 11 and 12 are made of aluminum.

As shown in FIG. 2, each of the circulation channels 14 for the heat-transfer fluid has a contour 15 that is substantially trapezoid-shaped in cross section, with two side walls 16 and a bottom wall 17, this bottom wall 17 being a small base of the trapezoid.

The channel 14 is provided, on the side walls 16 thereof, with a plurality of lateral disruption elements 18 for disrupting the flow of the heat-transfer fluid in this channel 14, and, on the bottom wall 17, with a plurality of bottom disruption elements 19.

These disruption elements 18 and 19 are arranged at a distance from one another.

The corners 20 of the trapezoid can be angular or rounded.

Each lateral disruption element 18 projects from the side wall 16 and has a base 21 that extends over the side wall 16, without encroaching on the bottom wall 17.

Each bottom disruption element 19 projects from the bottom wall 17, and

has a base 22 that extends over the bottom wall 17, without encroaching on the side walls 16.

Each of the disruption elements respectively 18 and 19 has a respective free end 23 and 24, i.e. the height thereof is selected to ensure that they do not come into contact with an opposing wall of the channel.

Each lateral disruption element 18 is substantially cylindrical with a base 21 having a circular contour, to generate turbulence in the fluid flow.

Each bottom disruption element 19 is chevron-shaped, comprising two branches 25 that join together at an apex 26, oriented so that the fluid flow first encounters the apex 26 and is then directed to both sides of the two branches 25 of the chevron to cause a local acceleration of the flow of the heat-transfer fluid.

The lateral disruption elements 18 are present on both side walls 16, forming pairs of lateral disruption elements 18 that face one another on both sides of the bottom wall 17.

Each side wall 16 is provided with a row 27 of lateral disruption elements 18 that are spaced apart from one another at a constant pitch in each row.

These lateral disruption elements 18 are all identical in each row 27.

The channel 14 has a row 28 of bottom disruption elements 19 that are spaced apart from one another at a constant pitch.

These bottom disruption elements 19 are all identical in each row 28.

The rows 27 of lateral disruption elements 18 are offset from the row 28 of bottom disruption elements 19 so that, in the direction X of the rows, the bottom disruption elements 19 are located between two consecutive pairs of lateral disruption elements 18.

The bottom disruption elements 19 are not aligned with the neighboring lateral disruption elements 18, but offset in the direction X.

This ensures a high heat exchange coefficient without unduly worsening the pressure drops, on account of the alternating turbulence-creation zones (resulting from the lateral disruption elements 18) and fluid-acceleration zones (resulting from the bottom disruption elements 19).

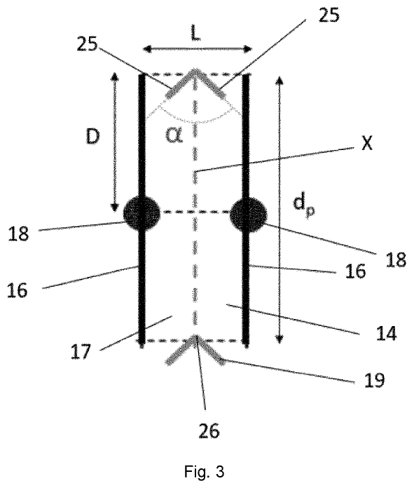

As illustrated in FIG. 3, the distance D, measured in the longitudinal direction X, between one of the bottom disruption elements 19 and the neighboring lateral disruption element 18, satisfies the following relationship: dp-L/(2 tan (α/2))<D<L/(2 tan (α/2)) where dp is the pitch between the bottom disruption elements 19, L is the width of the bottom wall 17 of the channel, and a is the angle at the apex 26 of the chevron shape.

This relationship means that the lateral disruption elements 18 are behind the triangle formed by the chevron-shaped bottom disruption element 19.

The disruption elements 18 and 19 are formed on a straight section 29 of the channel 14.

The disruption elements 18 and 19 are made on the lower plate, notably by drawing, stamping or metal additive manufacturing.

For example, the channel 14 has a succession of straight sections 29 connected together by bends.

The temperature control device 10 comprises a plurality of channels 14 arranged parallel to one another, and the channels 14 are provided with disruption elements 18 and 19 arranged as described above.

The upper plate 11 is substantially flat to be brought into thermal contact with the components 2 to be cooled.

The trapezoids of the contours of the channels 14 are isosceles trapezoids.

The bottom wall 17 is opposite the upper plate 11.

What is claimed is:

1. A temperature control device for an electrical component liable to give off heat during operation, comprising at least one circulation channel for a heat-transfer fluid and having, in cross section, a substantially trapezoid contour with two side walls and a bottom wall, the bottom wall corresponding to a small base of the trapezoid, with the at least one circulation channel being provided, on at least one of the side walls thereof, with a lateral disruption element for disrupting the flow of the heat-transfer fluid in the at least one circulation channel, and, on the bottom wall, with a bottom disruption element, with the lateral and bottom disruption elements being arranged at a distance from one another.

2. The temperature control device as claimed in claim 1, wherein the lateral disruption element projects from the side wall.

3. The temperature control device as claimed in claim 1, wherein the bottom disruption element projects from the bottom wall.

4. The temperature control device as claimed in claim 1, wherein the shape of the lateral disruption element is configured to generate turbulence in the fluid flow.

5. The temperature control device as claimed in claim 1, wherein the shape of the bottom disruption element is configured to cause a local acceleration of the flow of the heat-transfer fluid.

6. The temperature control device as claimed in claim 1, wherein the bottom disruption element is chevron-shaped and including two branches that join together at an apex.

7. The temperature control device as claimed in claim 1, further comprising a plurality of lateral disruption ed in first rows and a plurality of bottom disruption en el arranged in a second row, wherein the first rows of lateral disruption elements are offset from the second row of bottom disruption elements so that, in direction of the first and second rows, the bottom disruption elements are located between two consecutive pairs of lateral disruption elements.

8. The temperature control device as claimed in claim 1, further comprising a plurality of lateral disruption elements, wherein distance D, measured in the longitudinal direction, between one of the bottom disruption elements of the plurality of the bottom disruption elements and a lateral disruption element, satisfies the following relationship: dp-L/(2 tan (α/2))<D<L/(2 tan (α/2)) where dp is the pitch between the bottom disruption elements, L is the width of the bottom wall of the at least one circulation channel, and a is the angle at the apex of the chevron shape.

9. The temperature control device as claimed in claim 1, further comprising a plurality of lateral disruption elements, wherein distance D, measured in a longitudinal direction, between one of the bottom disruption elements of the plurality of the bottom disruption elements and neighboring lateral disruption element, satisfies the following relationship where dp is between the bottom disruption elements, L is the width of the bottom wall of the at least one circulation channel, and a is the angle at the apex of the chevron shape:

10. The temperature control device as claimed in claim 1, wherein the temperature control device further comprises an upper plate and a lower plate assembled with the upper plate in order to form together a plurality of the circulation channels for the heat-transfer fluid.

11. An assembly comprising
at least two electrical components liable to give off heat during operation, and
a temperature control device including at least one circulation channel for a heat-transfer fluid and having, in a cross section, a substantially trapezoid contour with two side walls and a bottom wall, the bottom wall corresponding to a small base of the trapezoid, with the at least one circulation channel being provided, on at least one of the side walls thereof, with a lateral disruption element for disrupting the flow of the heat-transfer fluid in the at least one circulation channel, and, on the bottom wall, with a bottom disruption element, with the lateral and bottom disruption elements being arranged at a distance from one another, arranged to cool at least two electrical components placed respectively on the temperature control device.
